(19) United States
(12) Patent Application Publication
(10) Pub. No.: US 2002/0010787 A1
(43) Pub. Date: Jan. 24, 2002

(54) Network connecting device

(76) Inventor: Shigenori Masuda, Kawasaki (JP)

Correspondence Address: STAAS & HALSEY LLP, 700 11TH STREET, NW, SUITE 500, WASHINGTON, DC, 20001, US

(21) Appl. No.: 09/814,760

(22) Filed: Mar. 23, 2001

(30) Foreign Application Priority Data
Jul. 3, 2000 (JP) 2000-200684

(51) Int. Cl. G06F 15/16

(52) U.S. Cl. 709/230; 709/236

(57) ABSTRACT

In the determining circuit, a protocol is set to each of the ports in compliance with the personal computer. The packet data analyzer reads out a data packet stored in the signal-receiving FIFO so as to analyze the protocol thereof, and notifies the result of the analysis to the determining circuit. In the determining circuit, when the result of the analysis is determined to coincide with the protocol set to the destination port, the data packet is sent to the signal-transmitting FIFO, and then output to the destination via the respective PHY chip and destination port.

### BACKGROUND OF THE INVENTION

1. Field of the Invention

The entire contents of Japanese Patent Application No. 2000-200684 filed on Jul. 3, 2000 are incorporated herein by reference.

The present invention relates to a network connecting device for avoiding an improper access from outside.

2. Description of the Related Art

In recent years, a local area network (LAN) is often set up such that it can be accessed from an external network such as the Internet, and therefore the necessity of the security on the LAN is increasing. Under these circumstances, presently, not only in a so-called open network, but also in a closed one such as the above-described LAN, the security of data is maintained by a server or client.

However, in the maintenance of the security by a server or client, a packet which is not necessary for ordinary data transmission and reception is circulated on the network and therefore the packet transmission efficiency is decreased.

On the other hand, a line concentrator (such as hub), a device (such as router) for interconnecting between different networks, and an interface device (such as LAN board) for connecting to a network, which is provided at an end portion of the network and used to connect itself to a computer (each of the device will be called network connecting device hereinafter, and the device constitute a network together with the server or client) do not have a security function in itself, and therefore they cannot exclude an improper access which may enter from outside.

### SUMMARY OF THE INVENTION

A first object of the present invention is to obtain a network connecting device having a security function in itself, by which the safety of the network can be maintained even in the case where the server or client is not able to conduct a sufficient performance for the security, and a decrease in the packet transmission efficiency, which may possibly occur by circulating unnecessary packets on the network, is avoided.

A second object is to achieve, in addition to the security function of the network connecting device itself, a multiple security on data on a network by enabling the security function by the server and/or client.

According to a first aspect of the present invention, there is provided a network connecting device which constitutes a network, comprising: at least one port; and a controller assigning one or more protocols to the at least one port. It may be arranged that the controller controls transmission/reception of a packet according to the protocol assigned to the at least one port.

In the network connecting device of the first aspect, one or more protocols are assigned to the at least one port. With this structure, the controller can transmit only packets having the coinciding protocols, and exclude those packets having different protocols. The reason why at least one port is specified in the network connecting device is that not only a line concentrator or router but also a LAN board are covered by the scope of this network connecting device.

According to a second aspect of the present invention, there is provided a network connecting device which constitutes a network, comprising: at least one port; and a controller assigning one or more packet formats to the at least one port. It may be arranged that the controller identifies a packet format of a packet which has been received and controls transmission of the received packet according to the identified packet format and the packet format assigned to the at least one port.

In the network connecting device of the second aspect, one or more arbitrary packet formats are assigned to the at least one port. With this structure, the controller can exclude those packets having formats which do not coincide, from being transmitted.

An assigned packet format may contain a security format type (for example, data added particularly for security). Further, it is possible that the format of the packet itself can be set originally other than the conventional specification.

According to a third aspect of the present invention, there is provided a network connecting device which constitutes a network, comprising: at least one port; and a controller specifying one or more ports permitted to communicate to the at least one port. It may be arranged that the controller controls transmission/reception of a packet according to the one or more ports permitted to communicate, specified to the at least one port.

According to the network connecting device of the third aspect, a packet can be transmitted only by a port to which communication is permitted, which is assigned to a respective port.

For example, in such a line concentrator having a plurality of ports, when a port is set to be communicable with a specific port (or specific ports), and a packet whose destination is a port other than that is received, the packet is not transmitted.

Further, in a network connecting device which usually has only one port, such as a LAN board, when a port is set to be communicable with a specific port of a specific network connection device other than the LAN board, and a packet transmitted from a source port other than that is not received by the network connecting device, or vice versa.

According to a fourth aspect of the present invention, there is provided a network connecting device which constitutes a network, comprising: at least one port; and a controller assigning one or more passwords to the at least one port. It may be arranged that the controller transmits, in response to reception of a packet from a source, a password input request packet to the source, and permits transmission of the received packet when a password contained in a response packet corresponding to the password input request packet coincides with a password assigned to a port connected to a destination of the received packet. The permission of the transmission of a packet means that the packet is transmitted to the port connected to the destination in the structure such as of a line concentrator having a plurality of ports. On the other hand, in the case of a structure such as a LAN board which usually has only one port, the permission of the transmission of a packet means that a transmission packet is received, and passed to a computer which contains such a LAN board.

According to a fifth aspect of the present invention, there is provided a network connecting device which constitutes a network, comprising: a plurality of ports; and a controller for transmitting, in response to reception of a packet from a source, a connection confirmation packet to a destination of the received packet via a port of the plurality of ports, which is connected to the destination, and transmitting the received packet to the destination when a response packet corresponding to the connection confirmation packet is returned via the port. This network connecting device may be of a type in which the controller prohibits transmission of the received packet when the response packet does not return within a predetermined time period.

In the network connecting devices according to the first to third aspect, the structure itself of the network connection device is equipped with a security function, and therefore even if there is no security system provided for other network connection device, clients or server, the safety of the network can be maintained, and further it is not necessary to circulate a packet for security. Here, when a security system is provided for the clients or server to be connected to the network where the line concentrator is present, it becomes possible to achieve a double security.

Further, in the network connecting devices according to the fourth and fifth aspect, a transmission packet is actually sent after confirming the safety by passing a particular packet over between the structure of the network connection device and other structure of the source or destination on the network, and therefore even if there is no security system provided for other network connection device, clients or server, the safety of the network can be maintained. Here, when a security system is provided for the clients or server to be connected to the network where the line concentrator is present, it becomes possible to achieve a double security.

It should be noted that the network connection device of the present invention is not limited to those discussed in the embodiments, but it is natural that the present invention can be remodeled into various versions as long as the essence of the invention remains. For example, the above-described various functions of the security controller (that is, the settings of protocol, packet format, communicable port, password, etc.) may be set in default in advance when the product is shipped.

### BRIEF DESCRIPTION OF THE DRAWINGS

These objects and other objects and advantages of the present invention will become more apparent upon reading of the following detailed description and the accompanying drawings in which:

FIG. 1 is a block diagram showing the structure of a network which uses a line concentrator 100 according to the first embodiment of the present invention;

FIG. 2 is a block diagram showing the structure of the line concentrator 100 shown in FIG. 1;

FIG. 3 is a diagram designed to illustrate a packet format;

FIG. 4 is a flowchart illustrating the procedure of a process executed in the line concentrator of the first embodiment;

FIG. 5 is a flowchart illustrating the procedure of a process executed in the line concentrator of the second embodiment;

FIG. 6 is a flowchart illustrating the procedure of a process executed in the line concentrator of the third embodiment;

FIG. 7 is a flowchart illustrating the procedure of a process executed in the line concentrator of the fourth embodiment; and

FIG. 8 is a flowchart illustrating the procedure of a process executed in the line concentrator of the fifth embodiment.

### DETAILED DESCRIPTION OF THE PREFERRED EMBODIMENTS

Embodiments of the present invention will now be described with reference to accompanying drawings.

### <First Embodiment>

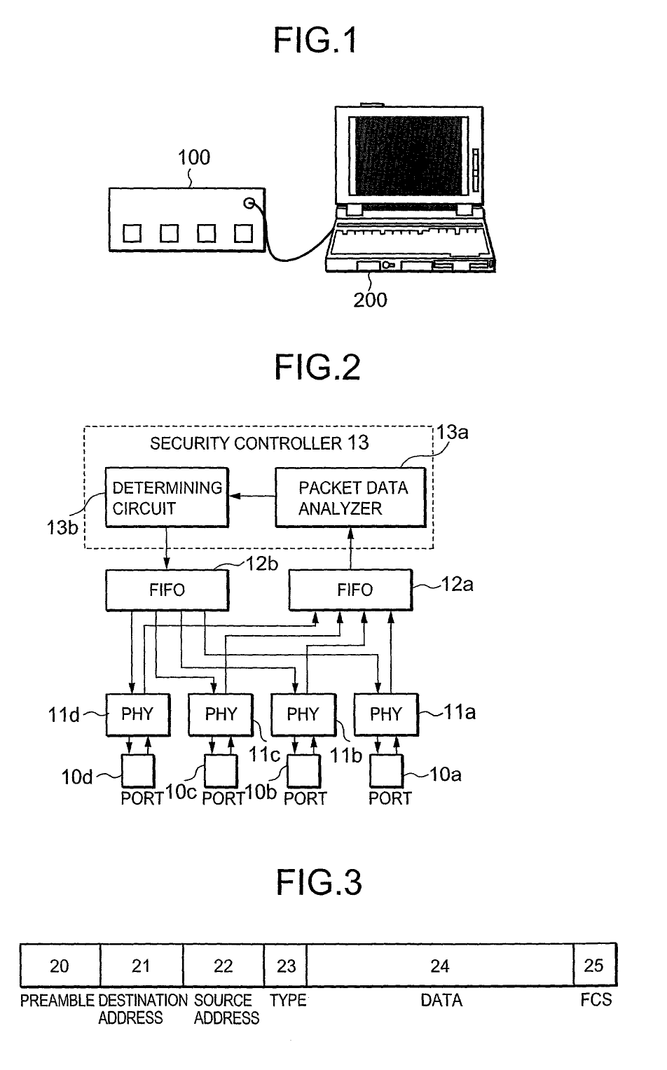

FIG. 1 shows a state where a personal computer 200 is connected to a line concentrator (hub) 100 according to the first embodiment of the present invention. The line concentrator 100 has a built-in security controller, which will be later explained, and thus the functional setting of the controller can be done by the personal computer 200 connected from the outside.

FIG. 2 is a block diagram showing the internal structure of the line concentrator 100. As shown in this figure, the line concentrator 100 includes four input/output ports 10a to 10b for packet signals, four PHY chips 11a to 11d each for converting a packet signal into a data packet format or demodulating a data packet into a packet signal, two FIFO (First-In First-Out) 12a and 12b each for temporarily storing a data packet, and a security controller 13 for analyzing and determining a data packet stored in the FIFO 12a.

The security controller 13 includes a packet data analyzer 13a for reading out a data packet stored in the FIFO 12a, and analyzing the read out packet, and a determining circuit 13b for making a determination for its security according to the result of the analysis.

The determining circuit 13b has a function of transmitting the data packet to that one (some) of the input/output ports 10a to 10d, which is connected to the destination (that one will be called destination port hereinafter) via the FIFO 12b and one (some) of PHY chips 11a to 11d, or discarding the data packet without transmitting it.

In the determining circuit 13 of the first embodiment, ports 10a to 10d are assigned with protocols respectively. The assigned protocol can be changed another protocol by the personal computer 200. The packet data analyzer 13a reads out a data packet stored in the FIFO 12a and analyzes its protocol. When it is determined by the determining circuit 13b that the analyzed protocol coincides with a protocol assigned to its destination port, the determining circuit 13b sends the data packet to the FIFO 12b and circulates the packet to the respective one of the ports 10a to 10d (the destination port) via the respective one of the PHY chips 11a to 11d.

The format of a packet generally has a structure such as shown in FIG. 3, in which it starts with a preamble 20, and then continues to a destination address 21, a source address 22, a type 23 for determining a protocol, data 24 containing original data of the packet, and a frame check sequence (FCS) 25 for performing an error check on the data in order. The type 23 stores a code indicating the format of a protocol (code used for identifying a protocol). For example, when this code is “0800”, it is an IP protocol, and it can be easily identified that it is a TCP/IP protocol.

Thus, the packet data analyzer 13a analyzes the contents of the destination address 21 and the protocol code of the type 23, and passes the results of the analysis to the determining circuit 13b. In the determining circuit 13b, it is determined to which of the destination portions this destination address corresponds, and whether or not the analyzed protocol code coincides with the protocol assigned to the destination port.

When the result of the determination indicates that they coincide with each other, the determining circuit 13b sends the data packet to the FIFO 12b, and transmits the packet to a respective one (destination port) of the ports 10a to 10d via the respective one of the PHY chips 11a to 11d.

When the analyzed protocol code and the protocol assigned to the destination port do not coincide with each other, the determining circuit 13b discards the data packet which has been received. For example, in the case where the packet is to be transmitted from the port 10a to the port 10b, and when the protocol of the data packet does not coincide with the protocol assigned to the port 10b, the packet is not transmitted to the port 10b. It should be noted that when the packet is discarded, it is preferable that such a message should be notified to the source (that is, a packet indicating that the protocols do not coincide should be sent to the port 10a side).

In this example, the protocol of the packet to be transmitted is determined whether or not it coincides with the protocol assigned to the respective destination port. However the present invention is not limited to this operation. It is also possible that a protocol is assigned for a port connected to the source (to be called source port hereinafter) in advance, and it is determined whether or not the protocol of the packet to be transmitted coincides with the protocol assigned to the source port. Then, only when they coincide with each other, the packet is transmitted to the destination port.

Further, in the case where different protocols are assigned to the destination port and source port, a separate structure for converting the protocol is prepared in advance in the security controller 13, and when the determining circuit 13b gives the permission of transmission, the protocol is converted so as to enable the transmission of the packet.

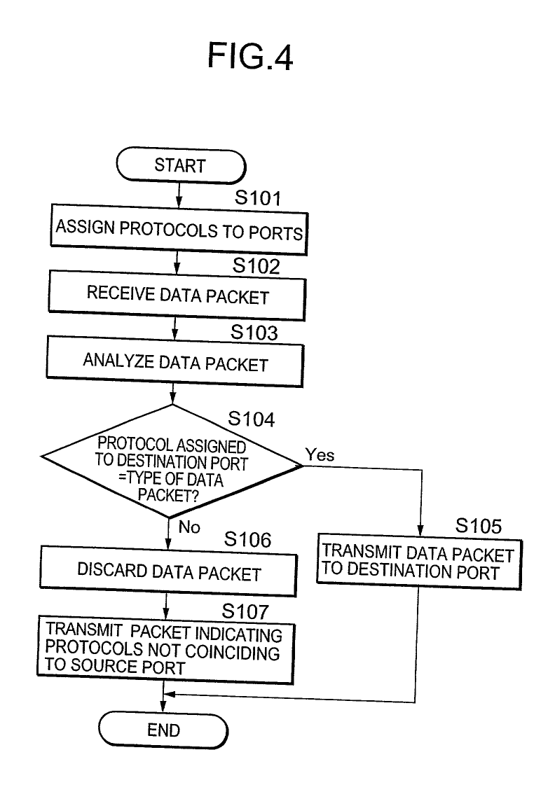

FIG. 4 is a flowchart illustrating the flow of the process carried out in the line concentrator 100 of the first embodiment. First, protocols are assigned to the input/output ports 10a to 10d respectively for determining circuit 13b by the personal computer 200 (step S101). Then, a packet signal is received by one of the ports, and then converted into a data packet format by the respective one of PHY chips 11a to 11d and stored temporarily in the FIFO 12a (step S102). After that, the data packet stored in the FIFO 12a is read by the packet data analyzer 13a of the security controller 13, to be analyzed (step S103).

The result of the analysis is passed to the determining circuit 13b, where it is checked whether or not the protocol assigned to the destination port coincides with the type 23 of the data packet (step S104). If they coincide with each other (YES in step S104), the data packet is transmitted to the destination port (via the FIFO 12b and the respective one of the PHY chips 11) by the determining circuit 13b (step S105). On the other hand, if they do not coincide (No in step S104), the data packet is discarded (step S106), and a packet notifying the protocols not coinciding is transmitted to the source port (step S107).

As described above, according to the first embodiment, protocols are assigned to the ports and the security controller 13 circulates only packets which have coinciding protocols. In this manner, packets of protocols which do not coincide with the assigned one can be excluded.

### <Second Embodiment>

The second embodiment of the present invention will now be described with reference to drawings. The feature of the second embodiment is that packet formats which can be transmitted are assigned to the ports of the line concentrator. The connection state between the line concentrator and the personal computer, and the structure of the line concentrator are similar to those of the first embodiment described above, and therefore the same reference numerals are used. Here, only functions and operations different from those of the first embodiment will be discussed, and detailed explanations for each element will be omitted.

In the determining circuit 13b, security format types, which can be set or revised by the personal computer 2000, are assigned to the ports 10a to 10d. The packet data analyzer 13a reads out a data packet stored in the FIFO 12a, and analyze its packet format, so as to determine whether or not it coincides with the security format type assigned to the destination port, in the determining circuit 13b. When determined that they coincide, the determining circuit 13 sends the data packet to the FIFO 12b, and transmits the packet to the respective one of the ports 10a to 10d (destination port) via the respective one of the PHY chips 11a to 11d.

In a packet to be transmitted, an area where the security format type is to be set, is provided in data 24 of the packet format shown in FIG. 3, and further in the determining circuit 13b, the security format types of a packet format are assigned to the ports by means of the personal computer 2000. For example, as the security format type, a value such as “FFFFFFFFFFFF000000000000FFFFFFFFFFFF000000000000h” is set.

Therefore, the packet data analyzer 13a analyses the destination data of the destination address 21 and the packet format of the data 24, and passes the results of the analysis to the determining circuit 13b. The determining circuit 13b identifies to which destination port the destination data corresponds, and determines whether or not the analyzed security format type coincides with the security format type assigned to the destination port.

When the result of the determination indicates these security format types coincide with each other, the determining circuit 13b sends the data packet to the FIFO 12b, and transmits the packet to a respective one (destination port) of the ports 10a to 10d via the respective one of the PHY chips 11a to 11d.

On the other hand, when they do not coincide with each other, the determining circuit 13b discards the data packet. For example, in the case where the packet is to be transmitted from the port 10a to the port 10b, and when the packet format of the data packet does not coincide with the format assigned to the port 10b, the packet is not transmitted to the port 10b. It should be noted that when the packet is discarded, it is preferable that such a message should be notified to the source (that is, a packet indicating that the packet formats do not coincide should be sent to the port 10a side).

In this example, the security format type of the data packet to be transmitted is determined whether or not it coincides with the packet format assigned to the respective destination port. However the present invention is not limited to this operation. It is also possible that a packet format is assigned for a port connected to the source in advance, and it is determined whether or not the security format type of the packet format to be sent coincides with the packet format assigned to the source port. Then, only when they coincide with each other, the packet is sent to the destination port.

Further, in the case where different packet formats are assigned to the destination port and source port, a separate structure for converting the packet format is prepared in advance in the security controller 13, and when the determining circuit 13b gives the permission of transmission, the format is converted so as to enable the transmission of the packet.

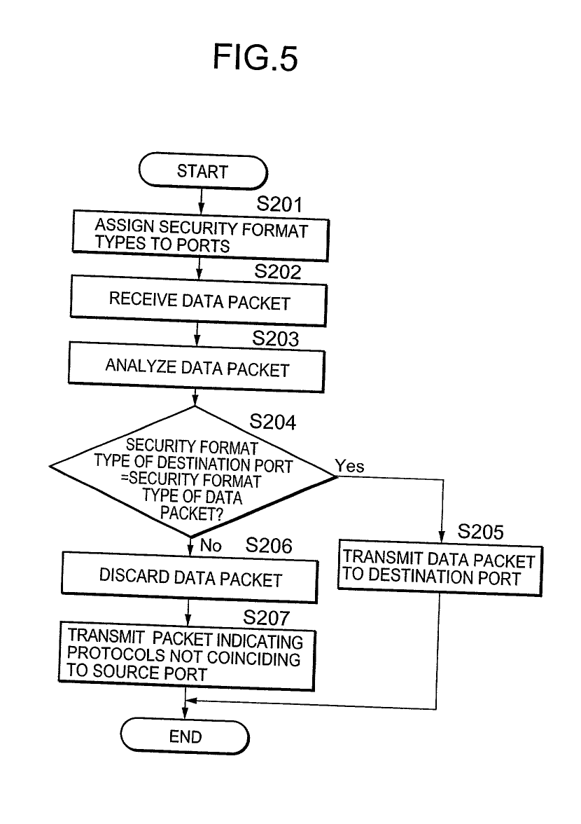

FIG. 5 is a flowchart illustrating the flow of the process carried out in the line concentrator of this embodiment. First, security format types are assigned to the input/output ports 10a to 10b respectively for the determining circuit 13b by the personal computer 200 (step S201). Then, a packet signal is received by one of the ports, and then converted into a data packet format by the respective one of PHY chips 11a to 11d and stored temporarily in the FIFO 12a (step S202). After that, the data packet stored in the FIFO 12a is read by the packet data analyzer 13a of the security controller 13, to be analyzed (step S203).

The result of the analysis is passed to the determining circuit 13b, where it is checked whether or not the security format type assigned to the destination port coincides with the type of the data packet (step S204). If they coincide with each other (YES in step S204), the data packet is transmitted to the destination port (via the FIFO 12b and the respective one of the PHY chips 11) by the determining circuit 13b (step S205). On the other hand, if they do not coincide (No in step S204), the data packet is discarded (step S206), and a packet notifying the packet formats not coinciding is transmitted to the source port (step S207).

As described above, according to the second embodiment, desired packed formats are assigned to the ports by the security controller 13, and thus security controller 13 can exclude packets of formats which do not coincide with the assigned one without transmitting them.

A packet format set by the security controller 13 may contain a security format type (for example, data added specially for security). It is also possible that the format of the packet itself can be set originally, that is, by other specification than that of the conventional one.

### <Third Embodiment>

Next, the third embodiment of the present invention will be described with reference to drawings. The feature of the third embodiment is that each of ports is assigned with one or more ports selected from the remaining ports for communication, which is specified in the line concentrator. The connection state between the line concentrator and the personal computer, and the structure of the line concentrator are similar to those of the first embodiment, and therefore the same reference numerals will be used. Only other functions and operations than those of the first embodiment will be described, and detailed descriptions for each structural member will be omitted.

In the determining circuit 13b, which of the ports is permitted to communicate with a destination port, that is, which port is communicable with a destination port, is set by the personal computer 200, and this setting can be revised by the computer. The packet data analyzer 13a reads out a data packet stored in the FIFO 12a, and analyses it at the destination address 21 and source address 22. Then, when the port specified by the source address is one of the communicable ports specified by the destination address, the determining circuit 13b sends the data packet to the FIFO 12b, and then transmits the packet to the communicable one of the ports 10a to 10d (destination port) via the respective one of the PHY chips 11a to 11d.

For example, in order to transmit a packet from the port 10a to the port 10b, when the port 10a and port 10b are set to be communicable, the packet is transmitted to the port 10b, whereas when they are not set to be communicable, the packet is not transmitted. When the packet is discarded, it is preferable that such a message should be notified to the source (that is, such a packet indicating that the communication with the port 10b is not permitted, is send to the port 10a).

In the above-described example, a communicable port is set to a destination port, and it is determined whether or not a port corresponding to the source address of the packet signal sent to the destination port coincides with a communicable port. However, the present invention is not limited to this example. For example, the following structure is also possible. That is, a communicable port is set to a source port, and it is determined whether or not a port corresponding to the destination address of the packet signal sent to the source port coincides with a communicable port. Then, only when they coincide, the packet is send to the destination port. The reason for proposing this alternative version is that in some cases, communicable ports set to the respective ports are set so as not to correspond to the respective ports.

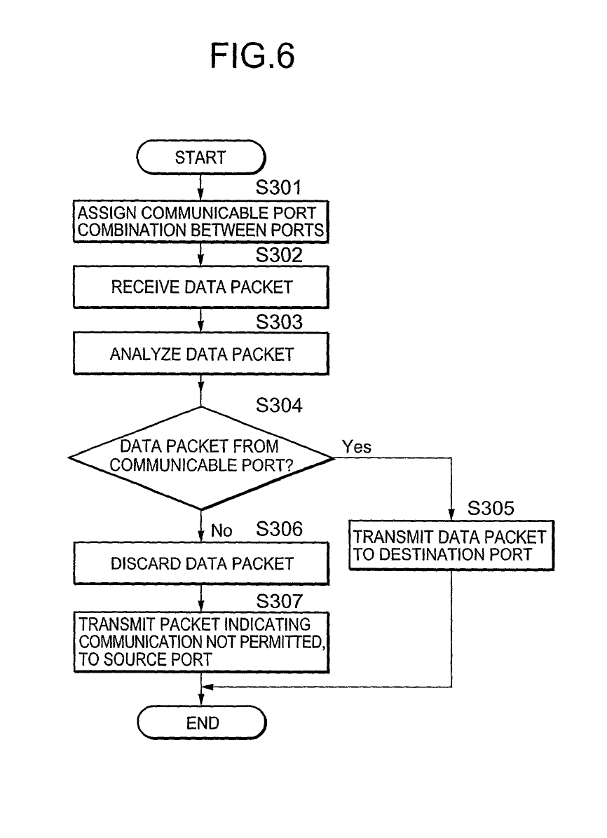

FIG. 6 is a flowchart illustrating the flow of the process carried out in the line concentrator of the third embodiment. First, one or more communicable ports are assigned to each of the input/output ports 10a to 10d for the determining circuit 13b by the personal computer 200 (step S301). Then, a packet signal is received by one of the ports, and then converted into a data packet format by the respective one of PHY chips 11a to 11d and stored temporarily in the FIFO 12a (step S302). After that, the data packet stored in the FIFO 12a is read by the packet data analyzer 13a of the security controller 13, to be analyzed (step S303).

The result of the analysis is passed to the determining circuit 13b, where it is checked whether or not the port corresponding to the source address 22 contained in the packet data is a communicable source port (step S304) by the circuit 13b. If the port is determined to be a communicable source port (YES in step S304), the data packet is transmitted to the destination port (via the FIFO 12b and the respective one of the PHY chips 11) by the determining circuit 13b (step S205). On the other hand, if it is not a source port (No in step S304), the data packet is discarded (step S306), and a packet notifying that communication with the target port is not permitted, is transmitted to the source port (step S307).

As described above, according to the third embodiment, data for specifying a port which is permitted to be communicable (communicable port) is set is assigned to each of the ports by the security controller 13, and a packet received via an arbitrary port is sent only to the port which is specified by this arbitrary port. That is, in such a line concentrator having a plurality of ports, when a port is set to be communicable with a specific port (or specific ports) by the security controller 13, and a packet whose destination is a port other than that is received, the packet is not transmitted.

Further, in a network connecting device which usually has only one port, such as a LAN board, when a port is set to be communicable with a specific port of a specific network connection device other than the LAN board by the security controller 13, and a packet transmitted from a source port other than that is not received by the network connecting device, or vice versa.

### <Fourth Embodiment>

Next, the fourth embodiment of the present invention will be described with reference to drawings. The feature of the fourth embodiment is that passwords are assigned to the ports of the line concentrator respectively. The connection state between the line concentrator and the personal computer, and the structure of the line concentrator are similar to those of the first embodiment, and therefore the same reference numerals will be used. Only other functions and operations than those of the first embodiment will be described, and detailed descriptions for each structural member will be omitted.

In the determining circuit 13b, passwords are assigned to the ports respectively by the personal computer 2000. In the security function achieved with the password, a password request packet is sent in a mail format to a source, and a response packet corresponding to the request packet is sent from the source. Further, only when the password contained in the response packet coincides with the set password, the transmission of the packet is permitted.

In order to achieve the above-described structure, a memory is provided in the determining circuit 13b, and mail data which requests the password is stored in advance. (Since the message contents to be sent are always the same, only one mail data is necessary.)

When a transmission packet is received by the packet data analyzer 13a, the destination address 21 and source address 22 of the packet are analyzed by the packet data analyzer 13a, and the password request packet is sent by the determining circuit 13b to the port specified with the source address.

On the other hand, the packet data analyzer 13a receives the response packet from the source, and the password contained in the packet is analyzed, then passed to the determining circuit 13b.

The determining circuit 13b determines whether or not the password passed coincides with the password assigned to the port. When these passwords coincide with each other, the transmission packet is circulated to the FIFO 12b, and transmitted to the destination port via the respective one of the PHY chips 11a to 11d. On the other hand, when they do no coincide, the packet is discarded, and such message is notified to the source (that is, such a packet indicating passwords not coinciding is sent to the source port).

For example, when a packet is to be transmitted from the port 10a to the port 10b and a password of “1234” is set to the port 10b, the determining circuit 13b sends a password request packet in the form of mail to the port 10a. When the response packet is sent from the port 10a and the password contained in the packet coincides with the password of “1234” set to the port 10b, the packet transmitted first is sent to the port 10b. On the other hand, when the passwords do not coincide, the packet is not transmitted, but such a packet indicating that the passwords do not coincide is transmitted to the port 10a.

In the above-described example, a password is set to a destination port, in order to maintain the security. However, the present invention is not limited to this example. For example, it is also possible that a password is set to a source port, in order to achieve a similar security function to that of the above.

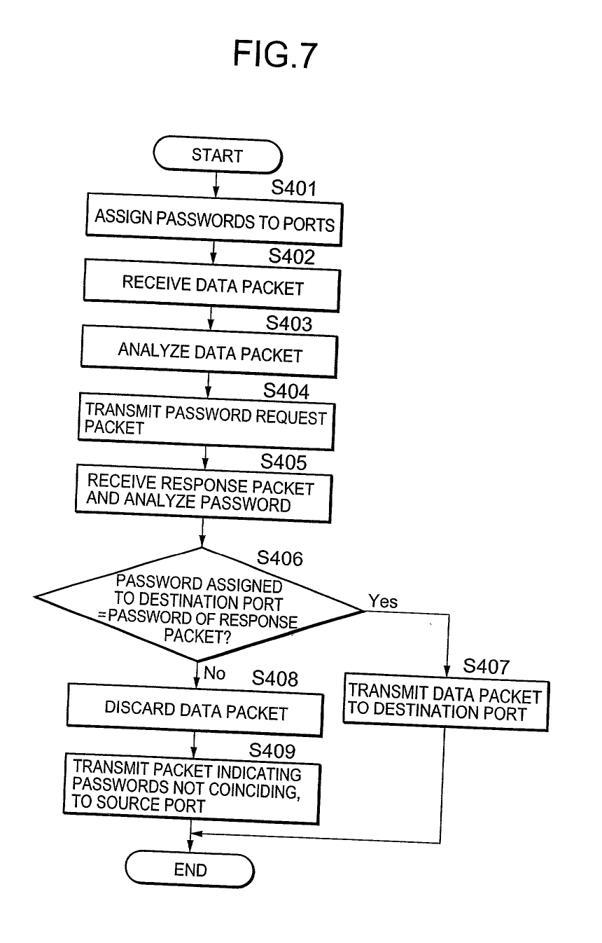

FIG. 7 is a flowchart illustrating the flow of the process carried out in the line concentrator of this embodiment. First, passwords are assigned to the input/output ports 10a to 10d for the determining circuit 13b by the personal computer 200 (step S401). Then, a packet signal is received by one of the ports, and then converted into a data packet format by the respective one of PHY chips 11a to 11d and stored temporarily in the FIFO 12a (step S402). After that, the data packet stored in the FIFO 12a is read by the packet data analyzer 13a of the security controller 13, to be analyzed (step S403).

The result of the analysis is passed to the determining circuit 13b, and the password request packet is transmitted to the port corresponding to the source address 22 contained in the packet data (step S404) by the circuit 13b.

The packet corresponding to the password request packet is received by the packet data analyzer 13a, where the password contained in the packet is analyzed (step S405).

The result of the analysis is passed to the determining circuit 13b, where it is checked whether or not the password set to the destination port and the password of the response packet coincide with each other (step S406) by the circuit 13b. If these passwords coincide with each other (YES in step S406), the data packet is transmitted to the destination port (via the FIFO 12b and the respective one of the PHY chips 11) by the determining circuit 13b (step S407). On the other hand, if they do not coincide (No in step S406), the data packet is discarded (step S408), and a packet notifying that passwords do not coincide, is transmitted to the source port (step S409).

As described above, according to the fourth embodiment, a password is assigned to each of the ports by the security controller 13. With this structure, when a transmission packet is received, the security controller 13 sends the password input request packet back to the source. Then, if the password contained in the response packet corresponding to the password input request packet received by the security controller, coincides with the assigned password, the transmission of the packet is permitted. The permission of the transmission of a packet means that the packet is transmitted to the port connected to the destination in the structure such as of a line concentrator having a plurality of ports. On the other hand, in the case of a structure such as a LAN board which usually has only one port, the permission of the transmission of a packet means that a transmission packet is received, and passed to a computer which contains such a LAN board.

### <Fifth Embodiment>

Next, the fifth embodiment of the present invention will be described with reference to drawings. The feature of the fifth embodiment is that when a packet is received by a line concentrator, a connection confirmation packet is sent to the destination, and only when the confirmation packet is confirmed, the received packet is sent to the destination. The connection state between the line concentrator and the personal computer, and the structure of the line concentrator are similar to those of the first embodiment, and therefore the same reference numerals will be used. Only other functions and operations than those of the first embodiment will be described, and detailed descriptions for each structural member will be omitted.

In this embodiment, a connection confirmation packet is sent in the format of mail to the destination via the port which is connected to the destination. In order to achieve the above-described structure, a memory is provided in the determining circuit 13b, and mail data which requests the permission of the reception of the packet is stored in advance. (Since the message contents to be sent are always the same, only one mail data is necessary.) Here, the mail data can be revised by the personal computer 200 in accordance with necessity.

With the above-described structure, when a transmission packet is received by the packet data analyzer 13a, the destination address 21 and source address 22 of the packet are analyzed by the packet data analyzer 13a, and the connection confirmation packet is sent by the determining circuit 13b to the destination via the port specified with the destination address.

When the packet data analyzer 13a received a response packet from the destination within a certain period of time, the contents of the packet are analyzed and passed to the determining circuit 13b.

The determining circuit 13b determines whether or not the contents of the response packet are those which are permitted to receive. When the contents are determined to be receivable, the transmission packet is sent to the FIFO 12b, and transmitted to the destination port via the respective one of the PHY chips 11a to 11d, and the port specified with the destination address. On the other hand, if it is determined that the contents of the response packet are not permitted to receive, the packet is discarded, and such message is notified to the source (that is, such a packet indicating it cannot be transmitted is sent to the source port). Further, when the response packet does not return within a certain period of time, the packet is discarded and a similar message is notified.

For example, when a packet is to be transmitted from the port 10a to the port 10b, the determining circuit 13b sends a connection confirmation packet in the form of mail to the destination via the port 10b. When the response packet is sent to the port 10b and the contents of the packet are determined to be receivable, the packet transmitted first is sent to the port 10b. On the other hand, when the contents are determined to be not receivable, the packet is not transmitted, but such a packet indicating that it may not be transmitted is sent to the port 10a.

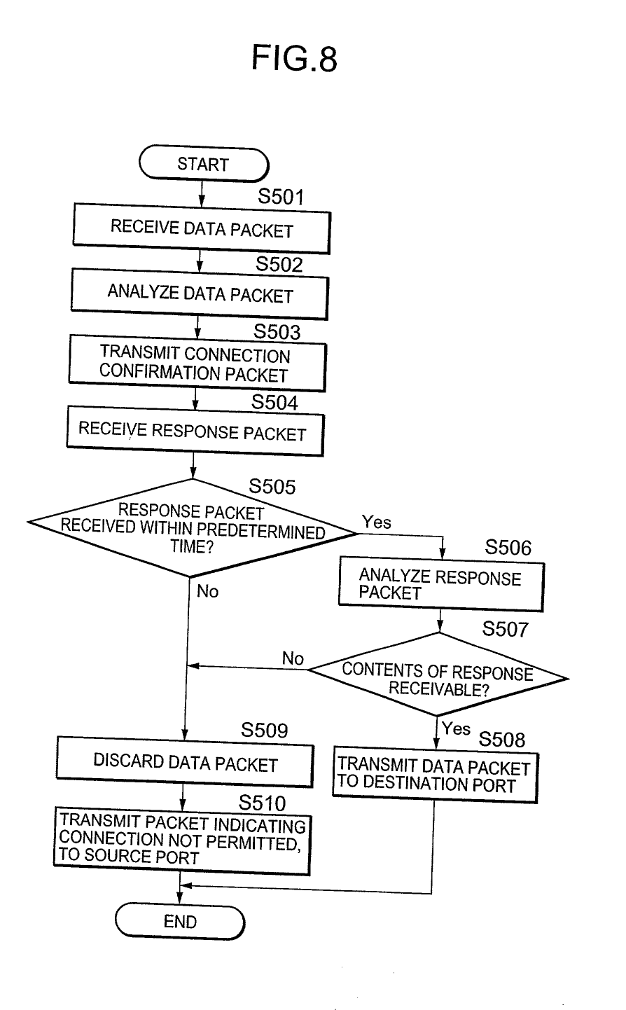

FIG. 8 is a flowchart illustrating the flow of the process carried out in the line concentrator of this embodiment. First, a packet is received by one of the input/output ports 10a to 10d, and then converted into a data packet format by the respective one of PHY chips 11a to 11d and stored temporarily in the FIFO 12a (step S501). After that, the data packet stored in the FIFO 12a is read by the packet data analyzer 13a of the security controller 13, to be analyzed (step S502).

The result of the analysis is passed to the determining circuit 13b, and the connection confirmation packet is transmitted to the destination via the port corresponding to the source address 21 contained in the packet data by the circuit 13b (step S503).

Then, the response packet corresponding to the connection confirmation packet is received by the packet data analyzer 13a, where it is checked if the response packet has returned within a certain period of time (step S505).

If the packet is returned within the predetermined time (YES in step S505), the contents of the packet are analyzed (step S506) and further it is further checked whether or not the contents are those permitted to receive (step S507). If the contents of the response packet are determined to be receivable (Yes in step S507), the data packet is transmitted to the destination via the destination port (via the FIFO 12b and the respective one of the PHY chips 11) by the determining circuit 13b (step S508). On the other hand, if the packet is not returned within the predetermined time (No in step S505), or the contents of the response packet are determined to be not receivable, the data packet is discarded (step S509), and a packet notifying that connection is not permitted, is transmitted to the source via the source port (step S510).

As described above, according to the fifth embodiment, when a transmission packet is received, the security controller 13 sends a connection confirmation packet to the source via the port connected to the destination. Further, such a response packet that permits the reception of the packet is returned to the port in response to the connection confirmation packet, the security controller 13 sends the transmission packet to the destination via the port connected to the destination. If the response packet is not returned within the predetermined time period, or the response packet indicates that the reception of the packet is not permitted, the security controller 13 does not send the transmission packet.

In the first to third embodiments described above, the structure itself of the network connection device is equipped with a security function, and therefore even if there is no security system provided for other network connection device, clients or server, the safety of the network can be maintained, and further it is not necessary to circulate a packet for security. Here, when a security system is provided for the clients or server to be connected to the network where the line concentrator is present, it becomes possible to achieve a double security.

Further, in the fourth and fifth embodiments described above, a transmission packet is actually sent after confirming the safety by passing a particular packet over between the structure of the network connection device and other structure of the source or destination on the network, and therefore even if there is no security system provided for other network connection device, clients or server, the safety of the network can be maintained. Here, when a security system is provided for the clients or server to be connected to the network where the line concentrator is present, it becomes possible to achieve a double security.

Lastly, the network connection device of the present invention is not limited to those discussed in the above embodiments, but it is natural that the present invention can be remodeled into various versions as long as the essence of the invention remains. For example, the above-described various functions of the security controller (that is, the settings of protocol, packet format, communicable port, password, etc.) may be set in default in advance when the product is shipped. Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. A network connecting device which constitutes a network, comprising:
at least one port; and
a controller assigning one or more protocols to the at least one port.

2. A network connecting device according to claim 1, wherein the controller controls transmission/reception of a packet according to the protocol assigned to the at least one port.

3. A network connecting device which constitutes a network, comprising:
at least one port; and
a controller assigning one or more packet formats to the at least one port.

4. A network connecting device according to claim 3, wherein the controller identifies a packet format of a packet which has been received and controls transmission of the received packet according to the identified packet format and the packet format assigned to the at least one port.

5. A network connecting device according to claim 4, wherein the packet format includes a security format type.

6. A network connecting device which constitutes a network, comprising:
at least one port; and
a controller specifying one or more ports permitted to communicate to the at least one port.

7. A network connecting device according to claim 6, wherein the controller controls transmission/reception of a packet according to the one or more ports permitted to communicate, specified to the at least one port.

8. A network connecting device which constitutes a network, comprising:
at least one port; and
a controller assigning one or more passwords to the at least one port.

9. A network connecting device according to claim 8, wherein the controller transmits, in response to reception of a packet from a source, a password input request packet to the source, and permits transmission of the received packet when a password contained in a response packet corresponding to the password input request packet coincides with a password assigned to a port connected to a destination of the received packet.

10. A network connecting device which constitutes a network, comprising:
a plurality of ports; and
a controller transmitting, in response to reception of a packet from a source, a connection confirmation packet to a destination of the received packet via a port of the plurality of ports, which is connected to the destination, and transmitting the received packet to the destination when a response packet corresponding to the connection confirmation packet is returned via the port.

11. A network connecting device according to claim 10, wherein the controller prohibits transmission of the received packet when the response packet does not return within a predetermined time period.
